(19) United States
(12) Patent Application Publication
(10) Pub. No.: US 2026/0228706 A1
(43) Pub. Date: Aug. 6, 2026

(54) A System for Identification of a Plastic Container for Re-Use or Recycling

(71) Applicant: INPRESS PRECISION LTD, Littlehampton Sussex (GB)

(72) Inventors: Henry POWELL, Littlehampton Sussex (GB); William POWELL, Littlehampton Sussex (GB)

(21) Appl. No.: 19/153,331

(22) PCT Filed: Feb. 5, 2024
(86) PCT No.: PCT/GB2024/050302

§ 371 Date: Aug. 3, 2025

(30) Foreign Application Priority Data
Feb. 4, 2023 (GB) 2301603.3

(51) Int. Cl. G06Q 10/30; B29B 17/00; B29B 17/02

(52) U.S. Cl. CPC G06Q 10/30; B29B 17/0052; B29B 17/02; B29B 2017/0015; B29B 2017/0068; B29B 2017/0089; B29B 2017/0279

(57) ABSTRACT

A system for the identification of a plastic product to establish its suitability for re-use or recycling. The system comprises: means to collect a plastic product after its use; means to identify the product; means to identify the chemical composition of the product once identified; means to capture and analyse the physical appearance of the product; computer processing means to select the subsequent processing step for the product dependent on the identification and analysis data. The processing step is one of breaking down the product into granular form or re-distributing the product for use.

### FIELD OF THE INVENTION

The present invention relates to a system for identification of a plastic container for re-use or recycling. Part of the system relates to a closed loop system of recycling of plastics to maintain conformity of the chemical composition.

### BACKGROUND

The recycling of plastic has become a major industry and will continue to grow as the world continues to deal with environmental issues.

The challenge with recycling plastic has always been dilution and altering of chemical composition of recycled plastic caused by the fact that the plastic to be recycled is collected from a wide variety of different sources. As a result, it is not currently possible to replicate a product precisely in a recycled form.

One cannot rely on the chemical composition of the recycled plastic, and the recycled plastic cannot be used for most plastic part production, after the first recycle. Instead, recycled plastic tends to be only suitable for low value products which do not require specific chemical properties.

The present invention seeks to provide a closed loop recycling process and method that ensures that the recycled plastic has the exact same chemical composition as the virgin plastic. As such, the process allows repeated recycling of plastic to form high-value products which require pure chemical composition, such as, for example, products suitable for the medical industry.

By using recycling in a closed loop process the same plastic can used (recycled) many times to make the same product. Extensive trials and experiments conducted by the applicant have indicated that a proprietary polypropylene formulation can be used to make the same product up to ten times whilst continuing to meet the same certification criteria.

The process is designed to be flexible to allow various plastic items to be separated through identification of their mechanical chemical formulation and processed differently according to the need.

There are many circumstances where re-use of a plastic product would be a preferred option.

In the medical waste industry re-use of plastic containers, such as “sharps bins”, has never been considered due to the hazardous waste that the bins contain. However, re-use would be preferable if the bin could be identified and its structure analysed with the conclusion reached that the bin is suitable for re-use, as opposed to be recycled or destroyed.

To this end, the present invention also seeks to provide a system that provides identification of a plastic product, typically a plastic container, and analysis of the physical, mechanical and chemical properties of the container to establish if the container is suitable for re-use or recycling.

### STATEMENTS OF INVENTION

According to a first aspect of the invention, there is provided a system for the identification of a plastic product to establish its suitability for re-use or recycling, the system comprising: means to collect a plastic product after its use; means to identify the product; means to identify the chemical composition of the product once identified; means to capture and analyse the physical appearance of the product; computer processing means to select the subsequent processing step for the product dependent on the identification and analysis data; said processing step being one of breaking down the product into granular form or re-distributing the product for use.

Preferably, the means to identify the product comprises one or more cameras.

Preferably, the means to capture the physical appearance of the product comprises one or more cameras.

Preferably, the plastic product is waste container, and the system further includes means to empty the container.

Preferably, the emptied contents are identified by one or more cameras.

Preferably, the system further includes means to sanitise the container once emptied.

Preferably, the system further includes means to heat the product to thereby soften the material.

According to a second aspect of the invention, there is provided a method of selecting a plastic product for re-use or recycling; the method comprising the steps of: identifying the product, including its initial chemical composition; capturing and analysing the physical appearance of the product; and selecting, based on the identification and analysis data whether the product should be recycled or re-used.

### BRIEF DESCRIPTION OF FIGURES

A preferred embodiment of the invention will now be described by way of example only and with reference to the figures, in which:

FIG. 1 is a flow diagram showing the general process steps of the system according to the invention; and

FIG. 2 is a more detailed flow diagram of the method steps of the system process for a plastic medical waste bin, for example.

### DETAILED DESCRIPTION OF EMBODIMENTS OF THE INVENTION

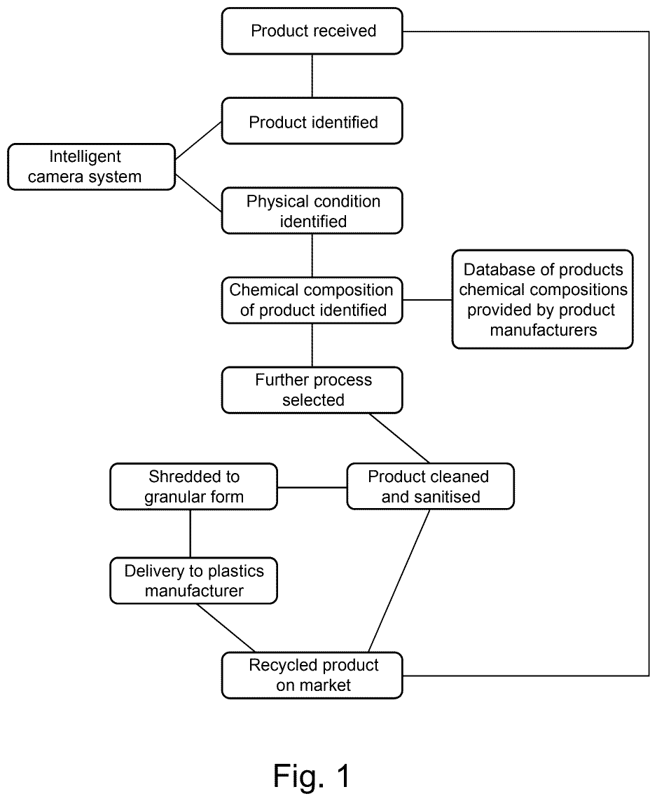

The general system will now be described with reference to the FIG. 1. The system provides for identification and analysis of a plastic product, typically a container, in a controlled environment to establish if the product is suitable for re-use or for recycling.

The system utilises a closed loop process with each processing step being carried out one or several authorised locations, pursuant to rigorous criteria and in one or more controlled environments to avoid any contamination. The identification and analysis steps are fully automated such that the system is suitable for medical and hazardous waste containers where human presence or contact would be undesirable.

The system is designed primarily for high value products and products that are used in environments where re-use is only suitable if the product remains strictly fit for purpose or where recycling suitability depends on the recycled product having the same physical, mechanical and chemical properties as the original virgin plastic product.

After there first use, products are delivered to the appropriate location and are processed into the system.

Each individual product is then transported to an identification and analysis area. If the plastic product is a container holding medical or other potential hazardous waste, the identification/analysis area is carefully controlled environment without access to anyone other than, authorised personnel.

Identification data relating to the product is collected using an integrated intelligent camera system working with AI software to capture images of barcode or QR codes on the product, and/or of product identifiers such as a product code, brand name, manufacturer or distributor information. The intelligent camera system comprises an artificial intelligence (AI) computer software, used in combination with a plurality of camera modules.

If the product has already been used or recycled one or more times, the recycling data will be collected through the barcode/QR code data. Previous use and/or recycling data is compared to the pre-determined criteria to establish if the further use and/or recycling of the product would exceed the number of times the material would be suitable for recycling or re-use.

At the same time as capturing product identification data, the camera system captures images of the product to analyse and identify the physical condition of the product. Images captured by the camera system will be compared to a images of the product manufacturer/distributor for comparison, if necessary.

In addition, whilst not shown in the figures, heat may be applied to the product to soften the plastic to allow for repair of any deformities or signs of stretching detected by the cameras, to return the product structure to its original shape and elasticity.

Once the product is identified by capturing images of the physical appearance the chemical composition of the identified product is gathered from data provided by the manufacturer at the point of first marketing of the virgin plastic product. All data gathered is captured in a database accessible by a computer processor within the system. AI software compares the identified product to the manufacturing data from database to determine the plastic composition of the product.

The identification and analysis data captured is then processed in order to select the subsequent processing step for the product.

If the number of times the product has been recycled, identified from the barcode/QR code, is equal to a pre-determined maximum then the subsequent process step selected would ordinarily be for the product to be incinerated.

Alternatively, the subsequent process selection would be one of re-use or recycling.

If the physical, mechanical and chemical properties of the product are such that the product is deemed to be re-usable in its form (subject to any treatment or repair as previously described), then the product is cleaned and sanitised for re-distribution. Suitable cleaning means may include but are not limited to an autoclave or an industrial chemical cleaner.

If the physical, mechanical and chemical properties of the product are such that the product is not deemed to be re-usable in its form then the product is shredded to granular form for recycling.

The plastic is shredded into a granular form using an array of shredders, each dedicated to a particular formulation of plastic to ensure material quality. For example, depending on the mechanical properties of the plastic in the product, the speed of the shredder may vary to ensure that all plastics are broken down uniformly.

The granular form of plastic ensures an ease of transportation. Once granulated, certificates for each batch of re-ground plastic are issued, certifying the precise chemical composition of the batch, as well as other information such as, for example, the number of times the plastic has been recycled.

Shredded/granulated plastic is then returned to a plastic manufacturer to produce a new product based on the certification information of the batch. The certification provides the factory with certainty of its composition, being as true to the original virgin product as possible allowing high-end recycled product.

The new product may have the certification information provided in QR code printed on the product for example to assist tracking of the product through its lifetime and to provide data to be captured by the camera systems when that product is returned to the present system after its further use.

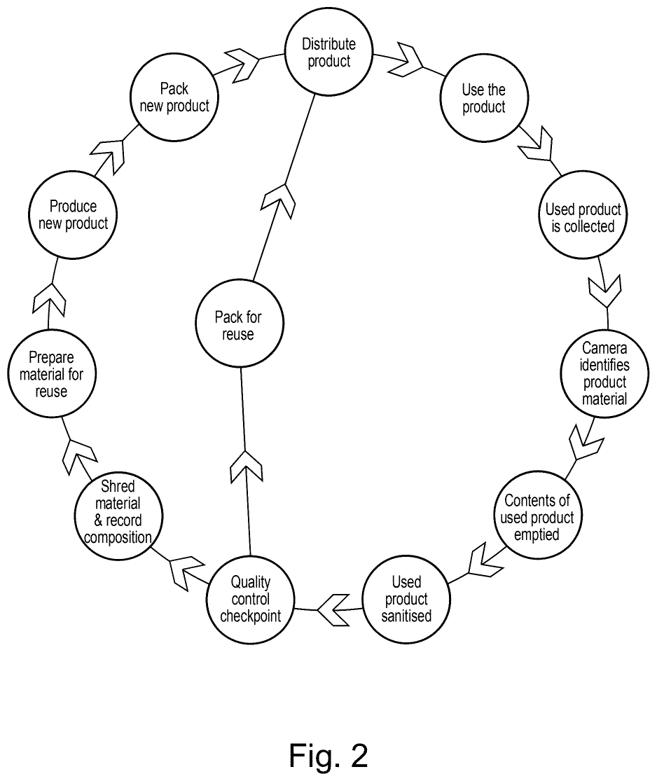

FIG. 2 illustrates the system in more detail, with a specific focus on sharps bins. Sharps bins are used to collect needles and other medical waste in hospitals and the like. Traditionally, once sharps bins are locked it is not possible to unlock the closure or remove the lid in order to prevent access to the contents. The sharps bin is then transported to a medical incinerator where the entire bin and its contents are incinerated. Sharp bins have therefore been designed specifically for single use.

The process of the present invention was conceived initially with sharps bins in mind to allow them to be recycled for re-use. Being a medical product, it is essential that the mechanical and chemical compositions are precisely replicated during recycling to make sure the recycled product continues to meet the required medical certifications and that its chemical and mechanical structure integrity is maintained.

It is envisaged though that the process and method has far larger application within general plastic recycling to increase the number of times a product can be made from the same material.

For example, the process may have application in recycling and/or returning bottles in the retail market.

The starting point is the manufacture and distribution of a sharps bin manufactured from a virgin plastic. Once sold in the market, the bin enters its usage cycle, where the bin is located in a medical facility for example.

Once the bin has completed its use cycle (when the bin is full and is typically ready for incineration) the bin is collected for delivery to a secure processing facility.

By using camera system, data is collected to identify the bin, together with any other important information captured from the barcode/QR code pertaining, for example, to the date the bin was sealed after use, as well as specific hospital and/or ward the bin was used.

Once identified, the product material composition is identified from manufacturer information, as previously described.

Based on the data captured from the camera system, the bin is either selected for re-use or recycling, or incineration.

If the bin is selected for re-use, the contents of the bin are emptied. During this time, images of the contents are captured and analysed by the camera system. The images are analysed using AI software.

Image capturing of the contents in real time allows identification of hazardous content material or potentially dangerous contents such as, for example, gas cannisters, and visual and/or oral alerts are provided to ensure removal and treatment before incineration. In the same way, valuable contents can be identified and removed.

Images of contents can be compared with internet image databases to identify products.

All data is collected and recorded to provide detailed visual and written contents reports.

As well as being required for the subsequent process selection in the system, the data reports can be shared and used by medical staff for auditing and training purposes; for example, to identify if the bins have been assembled and correctly used according to standard operating procedures in the facility.

The captured data records allow the system to provide, for example:
audit data, training requirements and feedback to the clinicians and location managers, which is required by NHS contract, about the correct use of the bins; whether they have been assembled correctly; if the corrects items are being disposed of; whether the hospital is purchasing the correct size bins; if the bins have been overfilled and are being use dangerously;
early identification of new diseases or particular disease increase, through examination of drug vials contained in the bins and mapping this spread geographically and by time;
identification of whether valuable products and materials are being disposed of in the bins; and predictions by day and location when valuable products may be present in bins;
removal of valuable products for recycling or re-use after sanitising;
identification of products that will be dangerous to incinerate, for example compressed gas canisters;
audited lists and datable feedback on alternate products that hospitals want to consider using and which might either be more cost effective and/or reduce carbon footprint further;
offer the opportunity for competitors to identify which medical location may be interested in their products; and
reports on the carbon footprint reductions achieved by use the bins by location and time.

Once the contents been removed, the bin is then sanitised.

Once empty and cleansed the structural quality of the bin is established. To this end, physical damage or deformities, including for example, visible signs of stretching of the plastic material, particularly around the catches that connect the bin and lid, are identified using the camera system. If possible, minor repairs may be carried out, for example by subjecting the bin to heat and manipulating the softened material to regain its original, shape, elasticity and appearance.

Following the quality control, a decision is made by the system, dependent on the identified bin characteristics, to either pack the bin for re-distribution or to process the bin for recycling.

Re-packing includes updating data to add to the number the bin has been re-used to be gathered when bin the enters the system again, once full.

Alternatively, if the product is not of satisfactory quality, it proceeds to be recycled as previously described.

1. A system for the identification of a plastic product to establish its suitability for re-use or recycling, the system comprising:
means to collect a plastic product after its use;
means to identify the product;
means to identify the chemical composition of the product once identified;
means to capture and analyse the physical appearance of the product;
computer processing means to select the subsequent processing step for the product dependent on the identification and analysis data;
said processing step being one of breaking down the product into granular form or re-distributing the product for use.

2. A system according to claim 1, wherein the means to identify the product comprises one or more cameras.

3. A system according to claim 2, wherein the means to capture the physical appearance of the product comprises one or more cameras.

4. A system according to claim 1, wherein the plastic product is waste container and the system further includes means to empty the container.

5. A system according to claim 4, wherein the emptied contents are identified by one or more cameras.

6. A system according claim 4, wherein the system further includes means to sanitise the container once emptied.

7. A system according claim 1, further including means to heat the product to thereby soften the material.

8. A method of selecting a plastic product for re-use or recycling; the method comprising the steps of:
identifying the product, including its initial chemical composition;
capturing and analysing the physical appearance of the product;
selecting, based on the identification and analysis data whether the product should be recycled or re-used.
